(19) United States
(12) Patent Application Publication
(10) Pub. No.: US 2026/0355913 A1
(43) Pub. Date: Nov. 12, 2026

(54) WRENCH FOR SOLAR MOUNTING SYSTEM

(71) Applicant: Tesla, Inc., Austin, TX (US)

(72) Inventors: Jacob PASTERNAK, Austin, TX (US); Dylon LEMUS, Austin, TX (US); Brencis PUKINSKIS, Austin, TX (US)

(73) Assignee: Tesla, Inc., Austin, TX (US)

(21) Appl. No.: 19/201,666

(22) Filed: May 7, 2025

(51) Int. Cl. B25B 13/50; H02S 20/23

(52) U.S. Cl. CPC B25B 13/50; H02S 20/23

(57) ABSTRACT

A wrench for a solar mounting system includes a handle portion, an intermediate portion extending from the handle portion, and an interface portion extending from the intermediate portion. The interface portion includes a first interface configured to engage a fastener to facilitate rotating the fastener in a first rotational direction and a second interface spaced from the first interface and configured to engage the fastener to facilitate rotating the fastener in an opposing second rotational direction.

### TECHNICAL FIELD

The present disclosure relates generally to solar mounting systems. More specifically, the present disclosure relates to a wrench for a solar mounting system for mounting a solar panel to a structure.

### BACKGROUND

Solar panels are often installed on roofs due to the exposure of such structures to sunlight. Some solar panels are mounted on the roof with various different fasteners and mounting configurations. It is desirable to provide a wrench that facilitates mounting a solar panel to roofs.

### SUMMARY

At least one embodiment relates to a wrench for a solar mounting system. The wrench includes a handle portion, an intermediate portion extending from the handle portion, and an interface portion extending from the intermediate portion. The interface portion includes a first interface configured to engage a fastener to facilitate rotating the fastener in a first rotational direction and a second interface spaced from the first interface and configured to engage the fastener to facilitate rotating the fastener in an opposing second rotational direction.

In some embodiments, the first interface defines a first interface opening oriented in a first direction and the second interface defines a second interface opening oriented in an opposing second direction. The first interface opening is configured to receive the fastener when the first interface engages the fastener. The second interface opening is configured to receive the fastener when the second interface engages the fastener.

In some embodiments, the first interface includes a first tooth extending at least partially in the first direction and the second interface includes a second tooth extending at least partially in the opposing second direction. The first tooth is configured to engage the fastener when the fastener is received by the first interface opening. The second tooth is configured to engage the fastener when the fastener is received by the second interface opening.

In some embodiments, the first tooth extends at least partially into the first interface opening and the second tooth extends at least partially into the second interface opening,

In some embodiments, the second interface opening is positioned nearer the handle portion than the first interface opening.

In some embodiments, the wrench includes a grip coupled to the handle portion, the grip configured to be grasped by an operator of the wrench.

In some embodiments, the handle portion defines a toothed profile configured to engage with interior portions of the grip.

In some embodiments, the fastener is a first fastener, the handle portion includes a third interface configured to engage a second fastener of the solar mounting system, the second fastener is a different type of fastener than the first fastener, and the third interface defines a third interface opening configured to receive the second fastener when the third interface engages the second fastener.

In some embodiments, the handle portion includes a fourth interface configured to engage a component of the solar mounting system. The fourth interface is positioned between the third interface and the intermediate portion.

In some embodiments, the wrench includes a tab extending from the handle portion, the tab having a predetermined width for spacing apart solar panels by the predetermined width.

In some embodiments, the handle portion and the tab cooperatively define a carabiner aperture extending therethrough.

In some embodiments, the handle portion defines a first plane and the interface portion defines a second plane substantially parallel to the first plane. The second plane offset is from the first plane.

In some embodiments, the intermediate portion defines one or more lanyard apertures extending therethrough.

In some embodiments, a length from an end of the interface portion to an end of the handle portion is greater than about 30 centimeters.

In some embodiments, a length from an end of the interface portion to an end of the handle portion is greater than or equal to about 32 centimeters.

In some embodiments, the interface portion defines a first alignment indicator and a second alignment indicator, at least one of the first interface or the second interface is configured to engage a second fastener of the solar mounting system to rotate the second fastener, aligning the first alignment indicator with a component of the solar mounting system while rotating the second fastener places the solar mounting system in a first configuration, and aligning the second alignment indicator with the component of the solar mounting system while rotating the second fastener places the solar mounting system in a second configuration.

At least one embodiment relates to a wrench for a solar mounting system. The wrench includes a first interface configured to engage a fastener to rotate the fastener in a first rotational direction and a second interface configured to engage the fastener to rotate the fastener in an opposing second rotational direction. The first interface defines a first interface opening oriented in a first direction. The first interface opening is configured to receive the fastener when the first interface engages the fastener. The second interface defines a second interface opening oriented in an opposing second direction. The second interface opening is configured to receive the fastener when the second interface engages the fastener.

In some embodiments, the first interface opening is oriented towards the second interface opening.

In some embodiments, the first interface opening is oriented away from the second interface opening.

At least one embodiment relates to a wrench for a solar mounting system. The wrench includes an interface portion defining a first interface and a second interface and a handle portion coupled to the interface portion. The interface portion defines a first plane. The interface portion is configured to separately engage a first fastener with the first interface to facilitate rotating the first fastener in a first rotational direction or the second interface to facilitate rotating the first fastener in a second rotational direction. The handle portion defines a second plane offset from the first plane. The handle portion defines a third interface configured to engage a second fastener of the solar mounting system and a fourth interface configured to engage a component of the solar mounting system. The fourth interface is positioned between the third interface and the interface portion. The first interface includes a first tooth extending from a first side of the interface portion. The first tooth is configured to engage a notch of the first fastener. The second interface includes a second tooth extending from an opposing second side of the interface portion. The second tooth is configured to engage the notch of the first fastener. The second fastener is a different type of fastener than the first fastener.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a block diagram of a solar mounting system for mounting a solar panel to a roof, according to an embodiment.

FIG. 2 is a perspective view of a solar wrench of the solar mounting system of FIG. 1 engaging a fastener of the solar mounting system, according to an embodiment.

FIG. 3 is a perspective view of the solar wrench of FIG. 2.

FIG. 4 is top view of the solar wrench of FIG. 2.

FIG. 5 is a side view of the solar wrench of FIG. 2.

FIG. 6 is a perspective view of the solar wrench of FIG. 2 being utilized to perform a hybrid installation associated with the solar mounting system of FIG. 1.

FIG. 7 is a side view of the solar wrench of FIG. 2 being utilized to space apart solar panels.

FIG. 8 is a side view of the solar wrench of FIG. 2 engaging a fastener of the solar mounting system of FIG. 1 with a first alignment.

FIG. 9 is a perspective view of the solar wrench of FIG. 2 engaging a fastener of the solar mounting system of FIG. 1 with a second alignment.

FIG. 10 is a perspective view of a solar wrench of the solar mounting system of FIG. 1, according to another embodiment.

FIG. 11 is another perspective view of the solar wrench of FIG. 10.

FIG. 12 is a perspective view of a solar wrench of the solar mounting system of FIG. 1, according to another embodiment.

FIG. 13 is a perspective view of a solar wrench of the solar mounting system of FIG. 1, according to another embodiment.

FIG. 14 is a perspective view of a solar wrench of the solar mounting system of FIG. 1, according to another embodiment.

FIG. 15 is a perspective view of a solar wrench of the solar mounting system of FIG. 1, according to another embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a solar mounting system (e.g., solar system, mounting system, etc.) facilitates mounting one or more solar panels to a roof. The mounting system includes a series of spanner bars that couple to the roof and series of leveling feet that couple the solar panels to the roof. The leveling feet may allow for a height of the solar panels from the roof to be adjusted. The leveling feet may be coupled to the mounting rails with fasteners. For example, the fasteners may be T-bolts extending through each leveling foot and into a slot of the spanner bar to couple the leveling foot to the spanner bar. A wrench for the solar mounting system is configured to engage the fasteners to facilitate rotating the fastener to couple and decouple the leveling feet from the mounting rails. The wrench may include a first interface configured to engage the fasteners to facilitate rotating the fasteners in a first rotational direction and a second interface configured to engage the fasteners to facilitate rotating the fasteners in a second rotational direction. For example, the first interface of the wrench may engage the fasteners to rotate the fasteners in the first rotational direction to couple the leveling feet to the spanner bars and the second interface of the wrench may engage the fasteners to rotate the fasteners in the second rotational direction to decouple the leveling feet from the spanner bars. Additionally, the wrench may include additional interfaces configured to engage other components of the solar mounting systems, permitting the wrench to facilitate utilizing the solar mounting system to mount the solar panels to the roof.

### Solar Mounting System

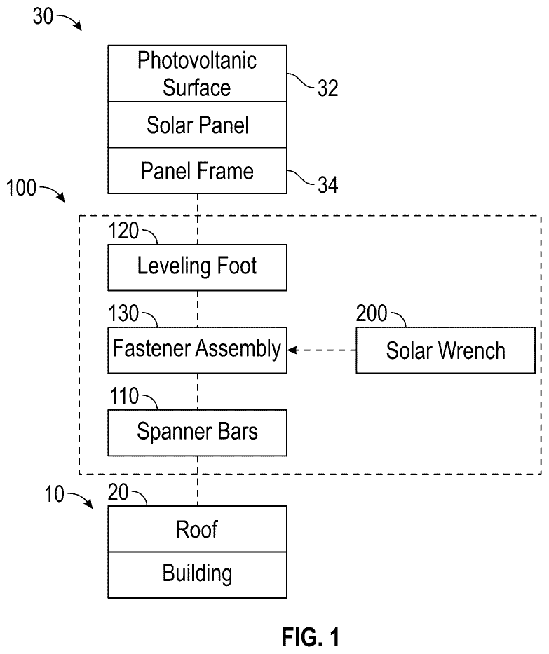

Referring to FIG. 1, a mounting system is shown as solar mounting system 100, according to an embodiment. The solar mounting system 100 is configured to mount a series of photovoltaic panels or photosensitive panels, shown as solar panels 30, to a roof assembly, cover, or awning, shown as roof 20, of a building, shown as building 10. The building 10 may be a residential building (e.g., a single-family home, an apartment building, etc.), a commercial building (e.g., a shop, a storage unit, etc.), a garage, a shed, a barn, a gazebo, or another type of covered structure. The building 10 may cover or contain people and/or items (e.g., furniture, appliances, vehicles, machinery, etc.).

As shown in FIGS. 1, 2, and 6-9, the solar panels 30 each have a surface, shown as photovoltaic surface 32, including a series of photovoltaic cells and a series of rails, shown as solar panel frame 34. The photovoltaic surface 32 may face upward when the solar panels 30 are mounted to the roof 20, such that the photovoltaic surface 32 is exposed to sunlight. The photovoltaic surface 32 may generate electrical energy in response to exposure to the sunlight, such that the solar panels 30 act as a source of electrical energy. The solar panels 30 may provide the generated electrical energy to power an electrical load (e.g., an appliance, a battery charger, a power grid, power storage, etc.). Accordingly, the solar panels 30 may power electrical loads associated with (e.g., positioned in or around) the building 10. The solar panel frame 34 extends around the photovoltaic surface 32. The solar panel frame 34 may provide mounting points that support the photovoltaic surface 32 and facilitate coupling the solar panels 30 to the roof 20. The building 10 may include more or fewer solar panels 30 based on the size of the building 10 and the energy demands of electrical loads.

The solar mounting system 100 may be installed on the roof 20 by one or more installation personnel (e.g., contractors, construction workers, operators etc.), referred to herein as an “installer.” The solar mounting system 100 supports the solar panels 30 and fixedly couples the solar panels 30 to the roof 20. The solar mounting system 100 may be adjustable or scalable (e.g., by adding or removing components) to accommodate different numbers or sizes of the solar panels 30. By way of example, components may be added to mount additional solar panels 30, or components may be removed if a smaller number of solar panels 30 are desired. By way of another example, components may be spaced farther from one another to accommodate larger solar panels 30, or components may be spaced closer together to accommodate smaller solar panels 30.

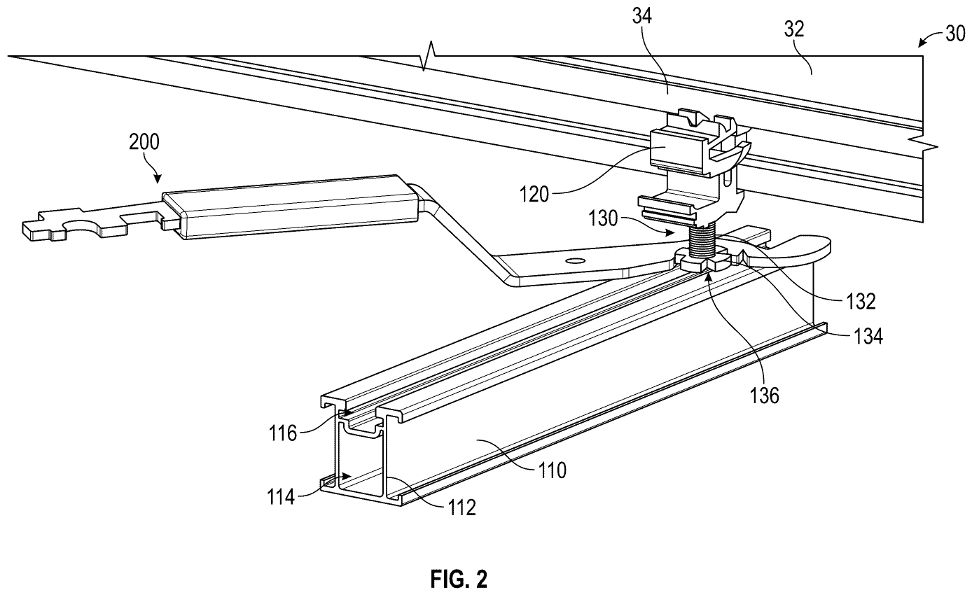

As shown in FIGS. 1 and 2, the solar mounting system 100 may include a rail (shown as spanner bar 110), one or more mounting interfaces, solar panel interfaces, alignment components, mounting brackets (shown as leveling feet 120) coupled to the spanner bar 110, a first coupler or first fastener assembly (shown as foot fastener assembly 130), selectively coupling a respective leveling foot 120 to the spanner bar 110, and a wrench (shown as solar wrench 200) configured to engage the foot fastener assembly 130.

The spanner bar 110 is coupled to the roof 20. For example, the spanner bar 110 may be fastened to a distal or upper end of a bracket or hook fastened to the roof 20 to couple the spanner bar 110 to the roof 20. The spanner bar 110 extends along the roof 20 (e.g., parallel to a plane of the roof 20). The solar mounting system 100 may include multiple spanner bars 110 coupled to and extending along the roof 20.

As shown in FIG. 2, the spanner bar 110 may be manufactured as an extrusion (e.g., an extruded tube, etc.). The spanner bar 110 may have a cross-sectional shape that is constant along the length of the spanner bar 110 (e.g., such that any two cross sections of the spanner bar 110 at different longitudinal positions along the length of the spanner bar 110 are substantially identical).

As shown in FIG. 2, the spanner bar 110 includes a tubular portion, central portion, main portion, or base portion, shown as body 112. The body 112 has a top side, a bottom, side, and a pair of laterally-facing sides each extending between the top side and the bottom side. An aperture or coupling passage, shown as central passage 114, extends longitudinally through the entirety of the body 112 (e.g., from a first longitudinal end of the spanner bar 110 to the second longitudinal end of the spanner bar 110). The central passage 114 is surrounded by the top side, the bottom sides, and the laterally-facing sides of the body 112. In other embodiments, the central passage 114 extends only partially along the length of the spanner bar 110.

The spanner bar 110 defines a slot, groove, or recess, shown as top slot 116, positioned along the top side of the body 112. The top slot 116 extends longitudinally along the entirety of the spanner bar 110 (e.g., from a first longitudinal end of the spanner bar 110 to the second longitudinal end of the spanner bar 110). The top slot 116 faces upward and away from the body 112. In other embodiments, the top slot 116 extends only partially along the length of the spanner bar 110. The top slot 116 may be configured to receive a portion of the foot fastener assembly 130 when the foot fastener assembly 130 is coupled to the spanner bar 110.

The leveling feet 120 each engage with the solar panel frame 34 to couple the solar panels 30 to the spanner bars 110. Accordingly, the leveling feet 120 couple the solar panels 30 to the spanner bar 110. The leveling feet 120 are spaced along length of the spanner bar 110. In some embodiments, the positions of the leveling feet 120 along the length of the spanner bar 110 are adjustable. This adjustability may facilitate adjusting the solar mounting system 100 to accommodate different configurations of the roof 20 and/or positions of the solar panels 30 without having to modify the spanner bar 110. Additionally, the leveling feet 120 may be adjustable to vary the height of the solar panels 30 (e.g., the distance between the solar panels 30 and the roof 20) to facilitate leveling the solar panels 30.

As shown in FIG. 2, the foot fastener assembly 130 includes a first fastener, shown as foot bolt 132, and a first nut, shown as foot nut 134, coupled to the foot bolt 132. The foot bolt 132 includes a head portion configured to be received within the top slot 116 of the spanner bar 110 to slidably couple the foot fastener assembly 130 to the spanner bar 110 and a body portion configured to couple to the leveling foot 120 such that the foot fastener assembly 130 may slidably couple the leveling foot 120 to the spanner bar 110. For example, the body portion of the foot bolt 132 may define male threads configured to engage female threads defined by the leveling foot 120 to couple the leveling foot 120 to the foot fastener assembly 130.

The foot nut 134 is in threaded engagement with the foot bolt 132. For example, the foot nut 134 may define female threads configured to engage the male threads defined by the foot bolt 132 that couple the foot fastener assembly 130 to the leveling foot 120. The foot nut 134 may engage a top surface of the spanner bar 110 proximate the top slot 116. When the foot nut 134 is tightened, the spanner bar 110 may be clamped or compressed between the foot bolt 132 (e.g., the head portion of the foot bolt 132, etc.) and the foot nut 134, fixing the foot fastener assembly 130 to the spanner bar 110 such that the leveling foot 120 may be fixed to the spanner bar 110 when the leveling foot 120 is coupled to the foot fastener assembly 130.

The solar wrench 200 may be used to engage the foot nut 134 to tighten and/or loosen the foot nut 134 to facilitate fixing the foot fastener assembly 130 to the spanner bar 110 and/or releasing the foot fastener assembly 130 from the spanner bar 110. For example, the solar wrench 200 may engage the foot nut 134 and rotate the foot nut 134 in a first rotational direction to move the foot nut 134 from a disengaged configuration into an engaged configuration to fix the foot fastener assembly 130 to the spanner bar 110. The solar wrench 200 may engage the foot nut 134 and rotate the foot nut 134 in an opposing second rotational direction to move the foot nut 134 from the engaged configuration into the disengaged configuration to release the foot fastener assembly 130 from the spanner bar 110. When the foot nut 134 is in the disengaged configuration the foot fastener assembly 130 may be slidably coupled to the spanner bar 110. In some embodiments, the foot fastener assembly 130 is configured be fixed to the spanner bar 110 and released from the spanner bar 110 with a quarter turn of the foot nut 134. For example, when the solar wrench 200 engages the foot nut 134 and rotates the foot nut 134 a quarter turn in the first rotational direction, the foot nut 134 may move from the disengaged configuration into the engaged configuration. When the solar wrench 200 engages the foot nut 134 and rotates the foot nut 134 a quarter turn in the opposing second rotational direction, the foot nut 134 may move from the engaged configuration into the disengaged configuration.

According to the embodiment shown in FIG. 2, the foot nut 134 defines a plurality of notches, shown as outer notches 136, configured to be engaged by the solar wrench 200. For example, the outer notches 136 may extend radially inward into a body portion of the foot nut 134 such that the solar wrench 200 may engage the outer notches 136 to apply a torque to the foot nut 134 via the outer notches 136. In some embodiments, the foot nut 134 defines four of the outer notches 136 spaced around an outside of the foot nut 134.

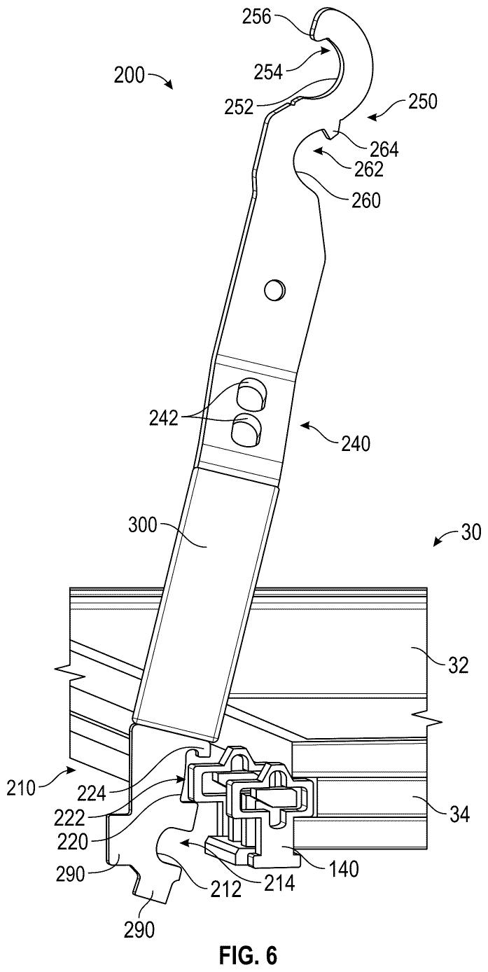

According to the embodiment shown in FIG. 6, the solar mounting system 100 includes a clip, shown as hybrid clip 140. The hybrid clip 140 may engage with the solar panel frame 34 as part of a hybrid installation of the solar panels 30 onto the roof 20. For example, the hybrid clip 140 may engage the solar panel frame 34 as part of an installation where the solar panels 30 on the roof 20 acts as a source of electrical energy to power the building 10 and provides excess of the electrical energy to a grid (e.g., an external grid, a grid system, etc.). The hybrid clip 140 may engage with the solar panel frame 34 to couple components associated with providing electrical energy to a grid to the solar panels 30 (e.g., wiring, etc.).

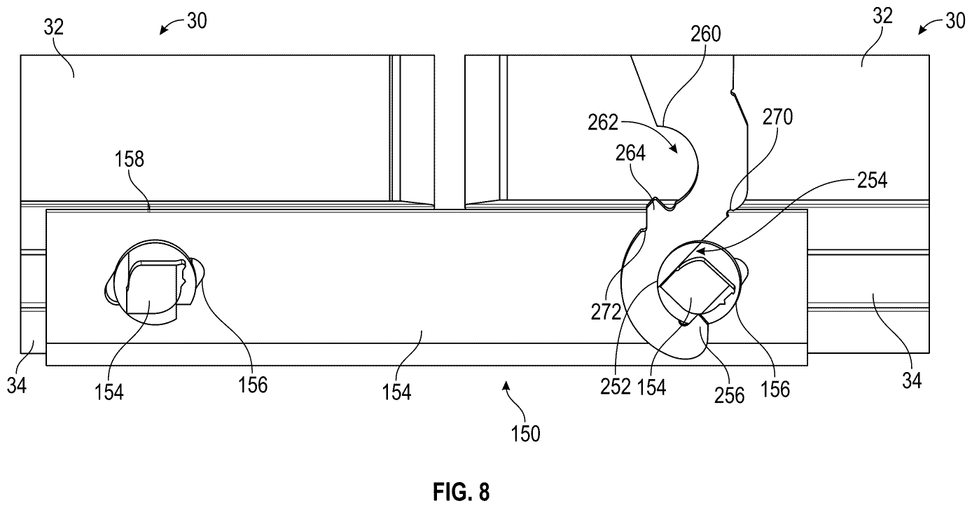

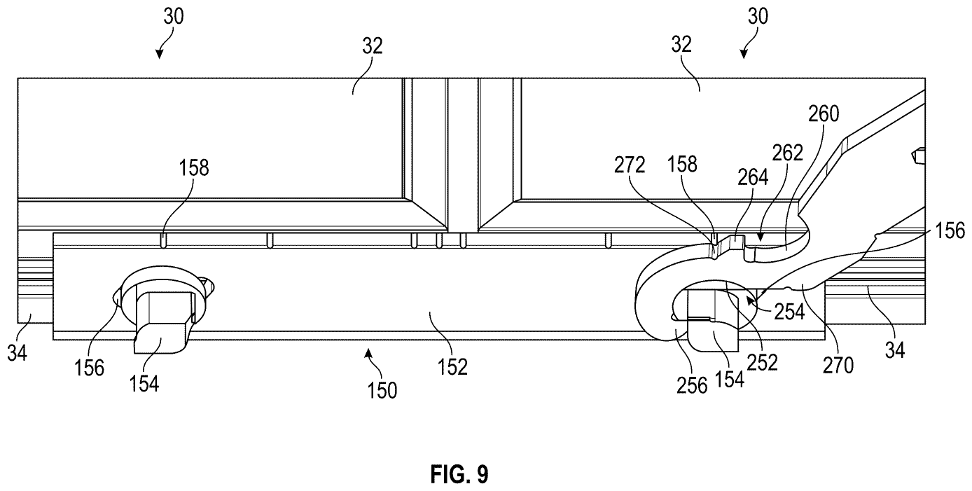

According to the embodiment shown in FIGS. 8 and 9, the solar mounting system 100 includes a locking assembly, shown as interlock assembly 150. The interlock assembly 150 may engage the solar panel frames 34 of multiple of the solar panels 30 to couple the solar panels 30 together. For example, when the interlock assembly 150 engages a first of the solar panel frames 34 of a first of the solar panels 30 and a second of the solar panel frames 34 of a second of the solar panels 30, the interlock assembly 150 may couple the first of the solar panels 30 to the second of the solar panels 30. In some embodiments, the interlock assembly 150 may be electrically coupled between the solar panels 30. For example, when the interlock assembly 150 engages a first of the solar panel frames 34 of a first of the solar panels 30 and a second of the solar panel frames 34 of a second of the solar panels 30, the interlock assembly 150 may electrically couple the first of the solar panels 30 to the second of the solar panels 30.

When the interlock assembly 150 is coupled to the solar panels 30, the interlock assembly 150 may space apart the solar panels 30 by a distance. In some embodiments, the interlock assembly 150 is adjustable between a first configuration that spaces apart the solar panels 30 by a first distance and a second configuration that spaces apart the solar panels 30 by a second distance where the second distance is greater than the first distance. For example, when mounting the solar panels 30 to the roof 20, the interlock assembly 150 may be placed in the first configuration to fully lock together the solar panels 30 and space the solar panels 30 apart by the first distance to minimize a footprint of the solar panels 30. As another example, when mounting the solar panels 30 to the roof 20, the interlock assembly 150 may be placed in the second configuration to space the solar panels 30 apart by the second distance to allow for the solar panels 30 to experience thermal expansion without contacting other of the solar panels 30. The interlock assembly 150 may be placed in the first configuration or the second configuration based on a number of the solar panels 30 installed on the roof 20.

As shown in FIGS. 8 and 9, the interlock assembly 150 includes a plate, shown as interlock plate 152, and a plurality of fasteners, shown as interlock fasteners 154, configured to engage the solar panel frames 34 to couple the interlock assembly 150 to the solar panels 30. The interlock plate 152 defines a plurality of apertures, shown as interlock apertures 156, extending through the interlock plate 152. Each of the interlock apertures 156 may align with coupling apertures defined by the solar panel frames 34 to selectively receive one of the interlock apertures 156 to couple the interlock plate 152 to the solar panels 30. For example, a first of the interlock apertures 156 may align with a first coupling aperture defined by a first of the solar panel frames 34 of a first of the solar panels 30 to receive a first of the interlock fasteners 154 and a second of the interlock apertures 156 may align with a second coupling aperture defined by a second of the solar panel frames 34 of a second of the solar panels 30 to receive a second of the interlock fasteners 154 to couple the first of the solar panels 30 to the second of the solar panels 30.

The interlock assembly 150 may be alternated between the first configuration and the second configuration based on a rotational orientation of the interlock fasteners 154. For example, when the interlock fasteners 154 are in a first rotational position, the interlock assembly 150 may be in the first configuration. When the interlock fasteners 154 are in a second rotational position, the interlock assembly 150 may be in the second configuration. The solar wrench 200 may engage the interlock fasteners 154 and rotate the interlock fasteners 154 between the first rotational position and the second rotational position to adjust the interlock assembly 150 between the first configuration and the second configuration. The interlock plate 152 may define a plurality of indicators, shown as alignment indicators 158, that facilitate indicating the configuration of the interlock assembly 150 to the installer of the solar mounting system 100. For example, the interlock plate 152 may define one of the alignment indicators 158 for each of the interlock apertures 156 that facilitate rotating the interlock fasteners 154 into the first rotational position or the second rotational position. When the solar wrench 200 engages one of the interlock fasteners 154, the installer of the solar mounting system 100 may align a first feature of the solar wrench 200 with one of the alignment indicators 158 corresponding to the one of the interlock fasteners 154 to place the one of the interlock fasteners 154 in the first rotational position or align a second feature of the solar wrench 200 with the one of the alignment indicators 158 to place the one of the interlock fasteners 154 in the second rotational position.

### Solar Wrench

The solar wrench 200 is configured to engage and/or interface with various portions of the solar mounting system 100 and/or the solar panels 30 to facilitate installation of the solar panels 30 onto the roof 20. For example, the solar wrench 200 may be configured to engage the foot nut 134 of the foot fastener assembly 130 to reconfigure the foot fastener assembly 130 between the engaged configuration and the disengaged configuration. As another example, the solar wrench 200 may engage the interlock fasteners 154 to reconfigure the interlock assembly 150 between the first configuration and the second configuration. As yet another example, the solar wrench 200 may engage the hybrid clip 140 to facilitate engaging the hybrid clip 140 with the solar panel frames 34. By engaging and interfacing with various portions of the solar mounting system 100 and the solar panels 30, the solar wrench 200 may facilitate installation of the solar panels 30 onto the roof 20 while reducing a number of tools required to be utilized by the installer compared to if each of the functions performed by the solar wrench 200 necessitated its own tool.

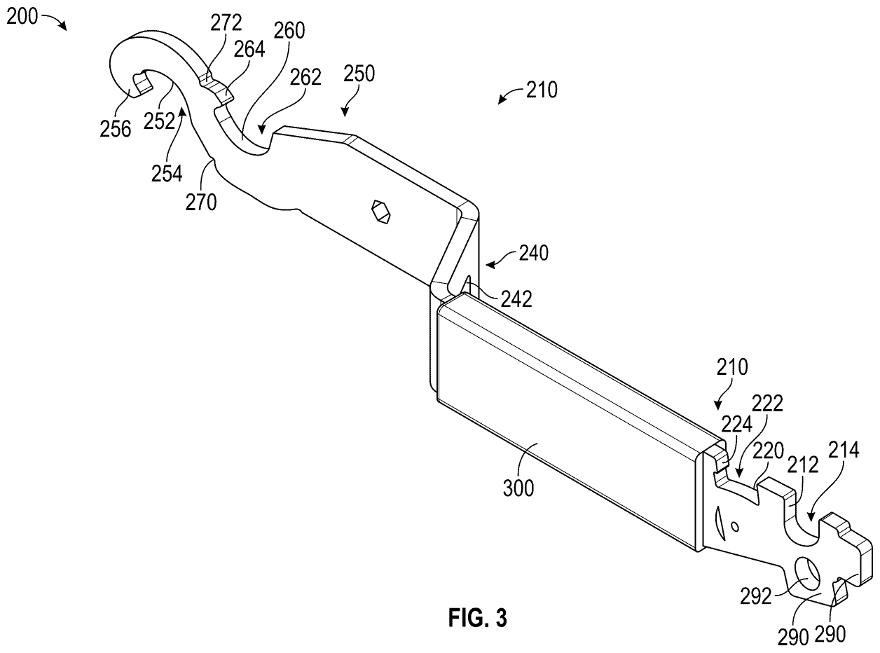

As shown in FIG. 3-7, the solar wrench 200 includes a first portion, shown as handle portion 210, a second portion, shown as intermediate portion 240, extending from the handle portion 210, and a third portion, shown as interface portion 250, extending from the intermediate portion 240. By way of example, the handle portion 210 may extend from a first end of the solar wrench 200 to the intermediate portion 240 and the interface portion 250 may extend from an opposing second end of the solar wrench 200 to the intermediate portion 240. In other embodiments, the interface portion 250 extends directly from the handle portion 210. For example, the handle portion 210 may extend from a first end of the solar wrench 200 to the interface portion 250 and the interface portion 250 may extend from an opposing second end of the solar wrench 200 to the handle portion 210.

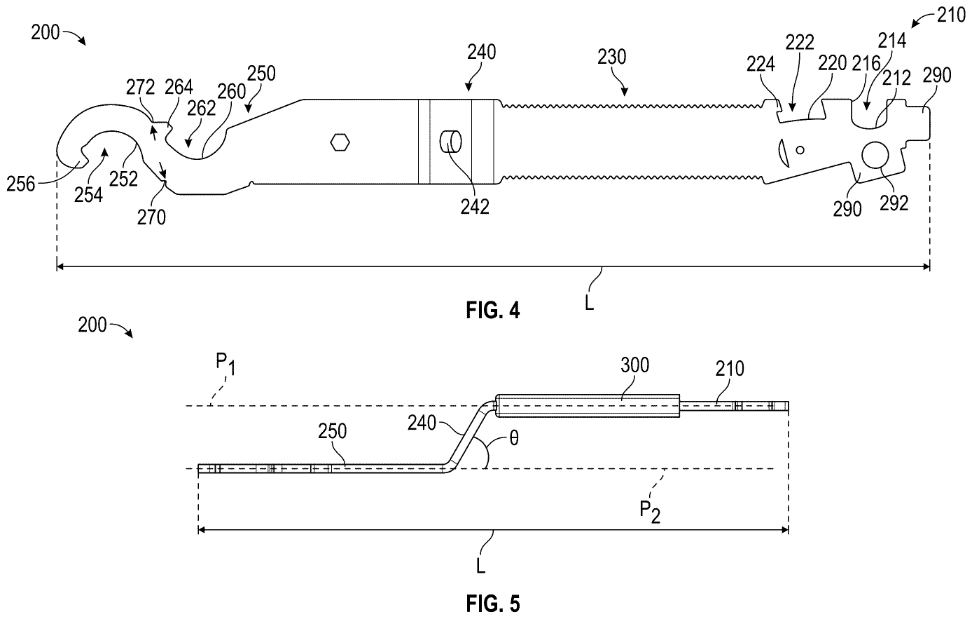

As shown in FIGS. 4 and 5, the solar wrench 200 has a length L from a first end of the solar wrench 200 to an opposing second end of the solar wrench 200 (e.g., from a distal end of the handle portion 210 to a distal end of the handle portion 210, etc.). According to an embodiment, the length L of the solar wrench 200 is greater than 30 centimeters (e.g., greater than 11.5 inches, greater than or equal to 32 centimeters, between 30 centimeters and 36 centimeters, less than 36 centimeters, etc.). By way of example, the length L may be about 32 centimeters (e.g., 32.191 centimeters). The length L may be longer than a length of a traditional solar wrench with comparable capabilities (e.g., comparable functionalities, etc.) as the solar wrench 200. The longer length L may increase a torque that the installer may apply on the fasteners of the solar mounting system 100 via the solar wrench 200 compared to a traditional solar wrench.

As shown in FIG. 5, the handle portion 210 defines a first plane, shown as plane P1, extending along the handle portion 210 and the interface portion 250 defines a second plane, shown as plane P2 extending along the interface portion 250. In some embodiments, the plane P2 is substantially parallel to the plane P1. The plane P2 may be offset from the plane P1. The intermediate portion 240 may extend between the plane P1 and the plane P2. The interface portion 250 being offset from the handle portion 210 may allow for the installer to grasp the handle portion 210 while the interface portion 250 engages a fastener of the solar mounting system 100. For example, when the interface portion 250 engages a fastener of the solar mounting system 100, the handle portion 210 may be offset upward and away from the roof 20 and/or the spanner bar 110 to allow for the installer to grasp the handle portion 210 and rotate the solar wrench 200 without the hand of the installer coming into contact with the roof 20 and/or the spanner bar 110.

As shown in FIG. 5, the intermediate portion 240 extends from the interface portion 250 to the handle portion 210 at an angle θ relative to the plane P2. In some embodiments, the angle θ is a non-perpendicular angle (e.g., less than 90 degrees, greater than 90 degrees. For example, the intermediate portion 240 may extend at a non-perpendicular angle relative to the handle portion 210 and/or relative to the interface portion 250. In other embodiments, the angle θ is a substantially perpendicular angle. For example, the intermediate portion 240 may extend at a substantially perpendicular angle relative to the handle portion 210 and/or the interface portion 250.

As shown in FIGS. 3, 4, 6, and 7, the handle portion 210 includes a first interface, shown as puck bolt interface 212 (e.g., a buried puck bolt interface, etc.), configured to engage a first type of the fasteners of the solar mounting system 100, and a second interface, shown as hybrid installation interface 220, configured to engage the hybrid clip 140 to facilitate engaging the hybrid clip 140 with the solar panel frames 34. The puck bolt interface 212 may be configured to engage a fastener of the solar mounting system 100 that is different from the foot nut 134 and/or the interlock fasteners 154. For example, the puck bolt interface 212 may be configured to engage a fastener of the solar mounting system 100 that has a different size and/or a different profile than the foot nut 134 and/or the interlock fasteners 154. The puck bolt interface 212 defines a first opening, shown as puck bolt opening 214, configured to receive one of the first type of the fasteners of the solar mounting system 100 when the puck bolt interface 212 engages the one of the first type of the fasteners of the solar mounting system 100. The puck bolt opening 214 may extend into the handle portion 210 from a side of the handle portion 210. As shown in FIG. 4, the puck bolt interface 212 includes a first engagement profile, shown as first serrated profile 216, extending at least partially along the puck bolt opening 214 to facilitate engaging the first type of the fasteners of the solar mounting system 100. For example, puck bolt interface 212 may include the first serrated profile 216 extending along a portion of the puck bolt opening 214 to facilitate engaging the first type of the fasteners of the solar mounting system 100.

As shown in FIGS. 3, 4, 6, and 7, the hybrid installation interface 220 is positioned between the puck bolt interface 212 and the intermediate portion 240. For example, the hybrid installation interface 220 may be positioned between the puck bolt interface 212 and the interface portion 250. The hybrid installation interface 220 defines a second opening, shown as hybrid installation opening 222, configured to receive a portion of the hybrid clip 140 to facilitate engaging the hybrid clip 140 with the solar panel frames 34. In some embodiments, the hybrid installation opening 222 extends into the handle portion 210 from a same side of the handle portion 210 as the puck bolt opening 214. For example, the hybrid installation opening 222 and the puck bolt opening 214 may extend into the handle portion 210 in the same direction. In other embodiments, the hybrid installation opening 222 and the puck bolt opening 214 extend into the handle portion 210 from different directions. For example, the puck bolt opening 214 may extend into a first side of the handle portion 210 and the hybrid installation opening 222 may extend into an opposing second side of the handle portion 210.

As shown in FIGS. 3, 4, 6, and 7, the hybrid installation interface 220 includes a first engagement tooth, shown as hybrid installation engagement tooth 224, configured to engage a portion of the hybrid clip 140. In some embodiments, the hybrid installation engagement tooth 224 extends into the hybrid installation opening 222. As shown in FIG. 6, the hybrid installation engagement tooth 224 engages a portion of the hybrid clip 140 to facilitate engaging the hybrid clip 140 with the solar panel frames 34. For example, the hybrid installation engagement tooth 224 may engage the portion of the hybrid clip 140 to releasably couple the hybrid clip 140 to the solar wrench 200 to facilitate coupling the hybrid clip 140 to the solar panels 30.

As shown in FIG. 4, the handle portion 210 defines a second engagement profile, shown as toothed profile 230, extending along a portion of the handle portion 210. The toothed profile 230 may be a serrated profile configured to engage another component to prevent the other component from slipping relative to the handle portion 210. For example, the installer may grasp the toothed profile 230 to prevent the hand of the installer from slipping relative to the handle portion 210. In some embodiments, the toothed profile 230 is configured to engage an interior profile of another component of the solar wrench 200 (e.g., the grip 300) such that movement of the other component of the solar wrench 200 relative to the handle portion 210 is inhibited.

As shown in FIGS. 3, 4, 6, and 7, the intermediate portion 240 defines one or more first apertures, shown as lanyard apertures 242, extending therethrough. For example, the intermediate portion 240 may define a pair of the lanyard apertures 242 extending through the intermediate portion 240. The lanyard apertures 242 may be configured to receive a lanyard (e.g., a rope, etc.) to facilitate releasably coupling the solar wrench 200 to another element. For example, the lanyard received by the lanyard apertures 242 may facilitate releasably coupling the solar wrench 200 to a belt of the installer to prevent the installer from losing the solar wrench 200. As another example, the lanyard received by the lanyard apertures 242 may facilitate releasably coupling the solar wrench 200 to a component of the solar mounting system 100 to prevent the solar wrench 200 from being separated from the component of the solar mounting system 100.

As shown in FIGS. 3, 4, and 6-9, the interface portion 250 includes a third interface, shown as first rotational interface 252, configured to engage a second type of the fasteners of the solar mounting system 100 to facilitate rotating the second type of the fasteners of the solar mounting system 100 in a first rotational direction, and a fourth interface, shown as second rotational interface 260, configured to engage the second type of the fasteners of the solar mounting system 100 to facilitate rotating the second type of the fasteners of the solar mounting system 100 in an opposing second rotational direction. The second rotational interface 260 may be positioned closer to the handle portion 210 than the first rotational interface 252. The first rotational interface 252 and the second rotational interface 260 may facilitate rotating the second type of the fasteners of the solar mounting system 100 in opposing directions without flipping the solar wrench 200. For example, the first rotational interface 252 may engage one of the fasteners of the solar mounting system 100 to facilitate rotating the one of the fasteners in the first rotational direction. While the first rotational interface 252 engages the one of the fasteners, the handle portion 210 may be positioned above the interface portion 250 (e.g., the plane P1 may be above the plane P2, etc.) The first rotational interface 252 may then disengage from the one of the fasteners and the second rotational interface 260 may engage the one of the fasteners without flipping the solar wrench 200 so that the interface portion 250 is above the handle portion 210. While the second rotational interface 260 engages the one of the fasteners, the handle portion 210 may remain positioned above the interface portion 250. Since the handle portion 210 remains above the interface portion 250 when either the first rotational interface 252 or the second rotational interface 260 engages the fasteners of the solar mounting system 100, the installer may grasp the handle portion 210 and rotate the solar wrench 200 in the first rotational direction to facilitate rotating the fasteners in the first rotational direction or rotate the solar wrench 200 in the opposing second rotational direction to facilitate rotating the fasteners in the opposing second rotational direction without the hand of the installer coming into contact with the roof 20 and/or the spanner bar 110.

In some embodiments, the first rotational interface 252 and the second rotational interface 260 are configured to engage the second type of the fasteners of the solar mounting system 100 that are a different type of fastener from the first type of the fasteners of the solar mounting system 100 that may be engaged by the puck bolt interface 212. For example, the first rotational interface 252 and the second rotational interface 260 may be configured to engage the foot nut 134 and the interlock fasteners 154 of the solar mounting system 100 and the puck bolt interface 212 may be configured to engage fasteners of the solar mounting system 100 other than the foot nut 134 and the interlock fasteners 154. In other embodiments, the first rotational interface 252, the second rotational interface 260, and the puck bolt interface 212 are configured to engage at least one of the same fasteners of the solar mounting system 100 (e.g., at least one of the fasteners of the solar mounting system 100 is included in the first type of the fasteners of the solar mounting system 100 and the second type of the fasteners of the solar mounting system 100, etc.).

As shown in FIGS. 3, 4, and 6-9, the first rotational interface 252 defines a third opening, shown as first interface opening 254, configured to receive one of the second type of the fasteners of the solar mounting system 100 when the first rotational interface 252 engages the one of the second type of the fasteners of the solar mounting system 100. The first interface opening 254 may extend into the interface portion 250 from a side of the interface portion 250. The first interface opening 254 may be oriented in a first direction. For example, a first mouth of the first interface opening 254 may be oriented in the first direction such that the first interface opening 254 may receive the second type of the fasteners of the solar mounting system 100 when the second type of the fasteners of the solar mounting system 100 approach the first rotational interface 252 from the first direction.

As shown in FIGS. 3, 4, and 6-9, the first rotational interface 252 includes a second engagement tooth, shown as first rotational tooth 256, configured to engage one of the second type of the fasteners of the solar mounting system 100 when the one of the second type of the fasteners of the solar mounting system 100 is received within the first interface opening 254. The first rotational tooth 256 may extend at least partially in the first direction of the orientation of the first interface opening 254. The first rotational tooth 256 may extend from a first side of the interface portion 250. In some embodiments, the first rotational tooth 256 extends at least partially into the first interface opening 254. The first rotational tooth 256 may engage one of the outer notches 136 of the foot nut 134 to facilitate rotating the foot nut 134 in the first rotational direction. For example, the first rotational tooth 256 may engage one of the outer notches 136 of the foot nut 134 to engage the first rotational interface 252 with the one of the first rotational tooth 256 to facilitate rotating the foot nut 134 in the first rotational direction to alternate the foot fastener assembly 130 from the disengaged configuration into the engaged configuration. The first rotational tooth 256 may engage the interlock apertures 156 to facilitate rotation the interlock apertures 156 in the first rotational direction. In some embodiments, the first rotational interface 252 includes a plurality of the first rotational teeth 256.

As shown in FIGS. 3, 4, and 6-9, the second rotational interface 260 defines a fourth opening, shown as second interface opening 262, configured to receive one of the second type of the fasteners of the solar mounting system 100 when the second rotational interface 260 engages the one of the second type of the fasteners of the solar mounting system 100. In some embodiments, the second interface opening 262 is positioned closer to the handle portion 210 than the first interface opening 254. The second interface opening 262 may extend into the interface portion 250 from a side of the interface portion 250. In some embodiments, the second interface opening 262 extends into an opposite side of the interface portion 250 as the first interface opening 254. For example, the first interface opening 254 may extend into a first side of the interface portion 250 and the second interface opening 262 may extend into an opposing second side of the interface portion 250. The second interface opening 262 may be oriented in a second opposing direction opposing the first direction of the first interface opening 254. For example, a second mouth of the second interface opening 262 may be oriented in the second opposing direction such that the second interface opening 262 may receive the second type of the fasteners of the solar mounting system 100 when the second type of the fasteners of the solar mounting system 100 approach the second rotational interface 260 from the opposing second direction.

As shown in FIGS. 3, 4, and 6-9, the second rotational interface 260 includes a third engagement tooth, shown as second rotational tooth 264, configured to engage one of the second type of the fasteners of the solar mounting system 100 when the one of the second type of the fasteners of the solar mounting system 100 is received within the second interface opening 262. The second rotational tooth 264 may extend at least partially in the opposing second direction of the orientation of the second interface opening 262. The second rotational tooth 264 may extend from an opposing second side of the interface portion 250, the opposing second side opposite the first side of the interface portion 250. In some embodiments, the second rotational tooth 264 is positioned nearer to the handle portion 210 than the first rotational tooth 256. In some embodiments, the second rotational tooth 264 extends at least partially into the second interface opening 262. The first rotational tooth 256 may engage one of the outer notches 136 of the foot nut 134 to facilitate rotating the foot nut 134 in the opposing second rotational direction. For example, the second rotational tooth 264 may engage one of the outer notches 136 of the foot nut 134 to engage the second rotational interface 260 with the one of the first rotational tooth 256 to facilitate rotating the foot nut 134 in the opposing second rotational direction to alternate the foot fastener assembly 130 from the engaged configuration into the disengaged configuration. The second rotational tooth 264 may engage the interlock apertures 156 to facilitate rotation the interlock apertures 156 in the opposing second rotational direction.

According to the embodiment shown in FIGS. 3, 4, and 6-9, the second interface opening 262 is oriented away from the first interface opening 254. For example, the first interface opening 254 may be oriented in the first direction that is away from the second interface opening 262 and the second interface opening 262 may be oriented in the second opposing direction that is away from the first interface opening 254. In other embodiments, the second interface opening 262 is oriented towards the first interface opening 254. For example, the first interface opening 254 may be oriented in the first direction that is towards the second interface opening 262 and second interface opening 262 may be oriented in the second opposing direction that is towards the first interface opening 254.

According to the embodiment shown in FIGS. 3, 4, 8, and 9, the interface portion 250 includes a first alignment indicator, shown as first alignment notch 270, and a second alignment indicator, shown as second alignment notch 272. As shown in FIG. 8, when the first rotational interface 252 engages one of the interlock fasteners 154, the first alignment notch 270 is configured to selectively align with one of the alignment indicators 158 to indicate to the installer that the one of the interlock fasteners 154 is in the first rotational position corresponding to the first configuration of the interlock assembly 150. As shown in FIG. 9, when the first rotational interface 252 engages one of the interlock fasteners 154, the second alignment notch 272 is configured to selectively align with one of the alignment indicators 158 to indicate to the installer that the one of the interlock fasteners 154 is in the second rotational position corresponding to the second configuration of the interlock assembly 150. In other embodiments, the first alignment notch 270 and the second alignment notch 272 selectively align with one of the alignment indicators 158 when the second rotational interface 260 engages one of the interlock fasteners 154 and the one of the interlock fasteners 154 is in the first rotational position and the second rotational position, respectively.

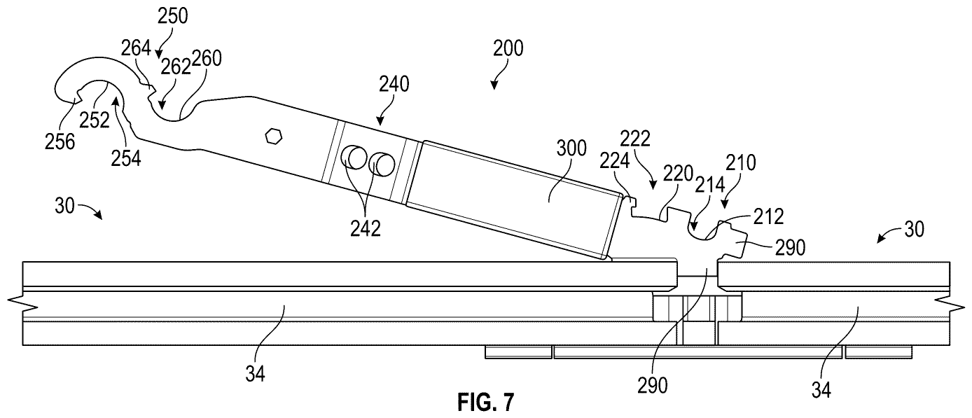

According to the embodiment shown in FIGS. 3, 4, 6, and 7, the solar wrench 200 includes at least one tabs, shown as spacer tabs 290, extending from the handle portion 210. The spacer tabs 290 may each have a predetermined width for spacing apart the solar panels 30 by the predetermined width when installing the solar panels 30 onto the roof 20. Each of the spacer tabs 290 may have a different predetermined width for spacing apart the solar panels 30 by one of the different predetermined widths when installing the solar panels 30 onto the roof 20. For example, as shown in FIG. 7, the installer may position one of the spacer tabs 290 between a first of the solar panels 30 and a second of the solar panels 30 and abut the solar panels 30 against the one of the spacer tabs 290 to space apart the solar panels 30 by the predetermined width of the one of the spacer tabs 290. The predetermined widths of the spacer tab 290 may correspond with spacings of the solar panels 30 that allows for thermal expansion of the solar panels 30 without the solar panels 30 contacting each other.

According to the embodiment shown in FIGS. 3 and 4, the handle portion 210 and one of the spacer tabs 290 cooperatively define a second aperture, shown as carabiner aperture 292, extending therethrough. For example, a first portion of the carabiner aperture 292 may extend through the handle portion 210 and a second portion of the carabiner aperture 292 may extend through one of the spacer tabs 290. The carabiner aperture 292 may be configured to receive a carabiner (e.g., a clip, etc.) to facilitate releasably coupling the solar wrench 200 to another element. For example, the carabiner received by the carabiner aperture 292 may facilitate releasably coupling the solar wrench 200 to a belt of the installer to prevent the installer from losing the solar wrench 200.

According to the embodiment shown in FIGS. 3 and 5-7, the solar wrench 200 includes a grip 300 (e.g., handle, etc.) coupled to the handle portion 210. The grip 300 may be configured to be grasped by the installer when the installer utilizes the solar wrench 200 to install the solar panels 30 onto the roof 20. For example, the grip 300 may be formed from a foam, leather, rubber, or other compliant material that increases a comfort of the installer grasping the grip 300 compared to if the installer directly grasped the handle portion 210. The toothed profile 230 of the handle portion 210 may engage with interior portions of the grip 300 to couple the grip 300 to the handle portion 210. For example, the toothed profile 230 may extend into the material of the grip 300 to engage the interior portions of the grip 300 such that movement of the grip 300 relative to the handle portion 210 is inhibited. In other embodiments, the grip 300 is coupled to the handle portion 210 through other means (e.g., fasteners, adhesive, etc.).

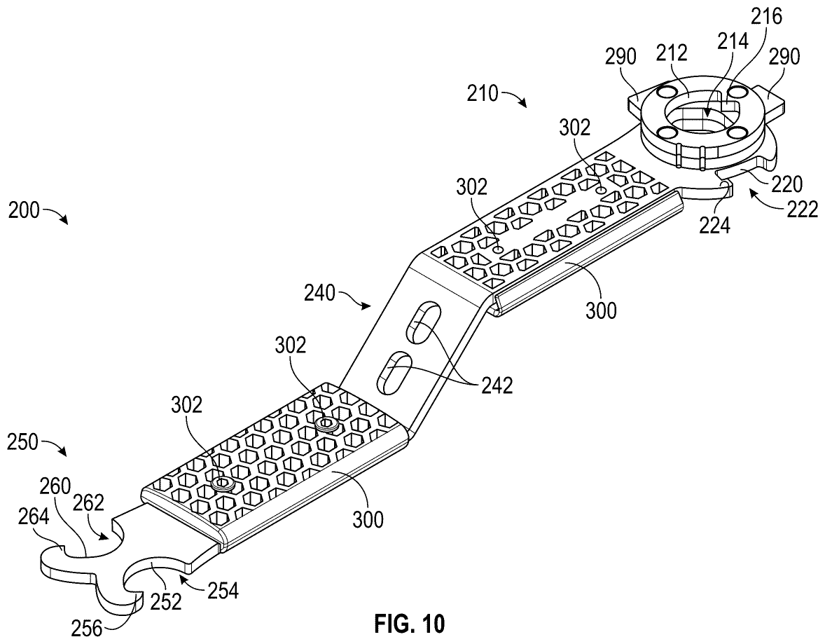

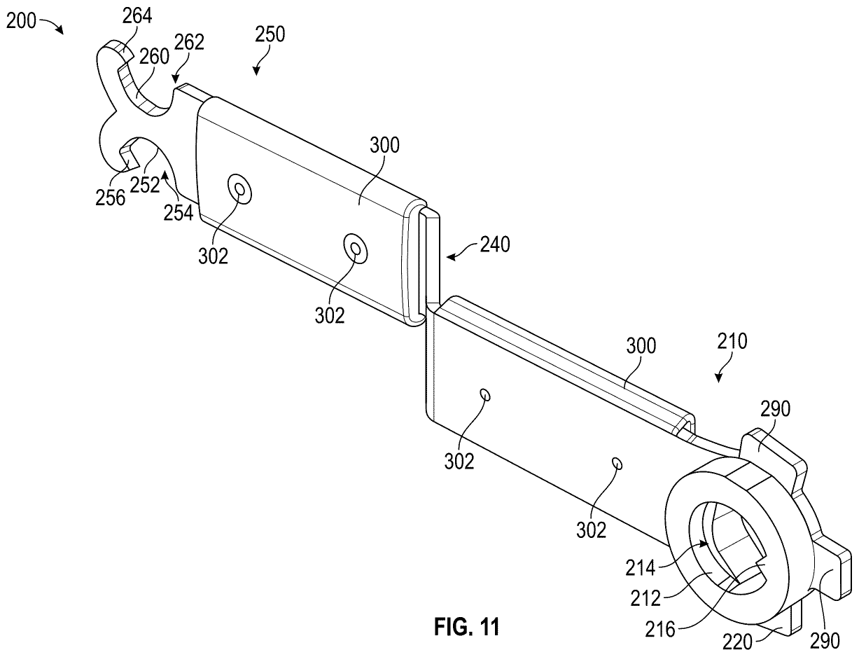

Referring to FIGS. 10 and 11, an alternative embodiment of the solar wrench 200 is shown. The solar wrench 200 of FIGS. 10 and 11 may be substantially similar to the solar wrench 200 of FIG. 2-9 except as otherwise described herein. The solar wrench 200 of both FIGS. 10 and 11 and FIG. 2-9 may facilitate installation of the solar panels 30 onto the roof 20 with the solar mounting system 100. By way of example, the installer may utilize the solar wrench 200 of FIGS. 10 and 11 instead of the solar wrench 200 of FIG. 2-9 based on a desired characteristic of the installation.

In the solar wrench 200 of FIGS. 10 and 11, the puck bolt interface 212 is centered in the handle portion 210 and the puck bolt opening 214 extends through the handle portion 210. Accordingly, this increases a strength of the handle portion 210 by increasing an amount of material in the puck bolt interface 212. This arrangement increases a torque that may be transferred from the solar wrench 200 to the first type of the fasteners of the solar mounting system 100.

In the solar wrench 200 of FIGS. 10 and 11, the second interface opening 262 and the first interface opening 254 are equidistant (e.g., a same distance, etc.) from the handle portion 210. For example, a first distance between the grip 300 coupled to the handle portion 210 and the first interface opening 254 and a second distance between the grip 300 coupled to the handle portion 210 and the second interface opening 262 may be equal. Accordingly, when the first rotational interface 252 or the second rotational interface 260 engage the second type of the fasteners of the solar mounting system 100, the installer may apply equal torques on the second type of the fasteners of the solar mounting system 100 engaged by the first rotational interface 252 or the second rotational interface 260 when the installer applies equal forces in opposing directions to the handle portion 210.

In the solar wrench 200 of FIGS. 10 and 11, the solar wrench 200 includes a plurality of the grips 300. A first of the grips 300 is coupled to the handle portion 210 and a second of the grip 300 is coupled to the interface portion 250. Accordingly, the installer may grasp (i) the first of the grips 300 when engaging the second type of the fasteners of the solar mounting system 100 with the first rotational interface 252 or the second rotational interface 260 or (ii) the second of the grips 300 when engaging the first type of the fasteners of the solar mounting system 100 with the puck bolt interface 212 or the hybrid clip 140 with the hybrid installation interface 220. Each of the grips 300 is coupled to the handle portion 210 or the interface portion 250 via a plurality of fasteners, shown as grip fasteners 302. For example, the grips 300 may each define a plurality of grip apertures extending through the grips 300 and each configured to selectively align with one aperture of the handle portion 210 or the interface portion 250 to receive one of the grip fasteners 302 to couple the grip 300 to the handle portion 210 or the interface portion 250.

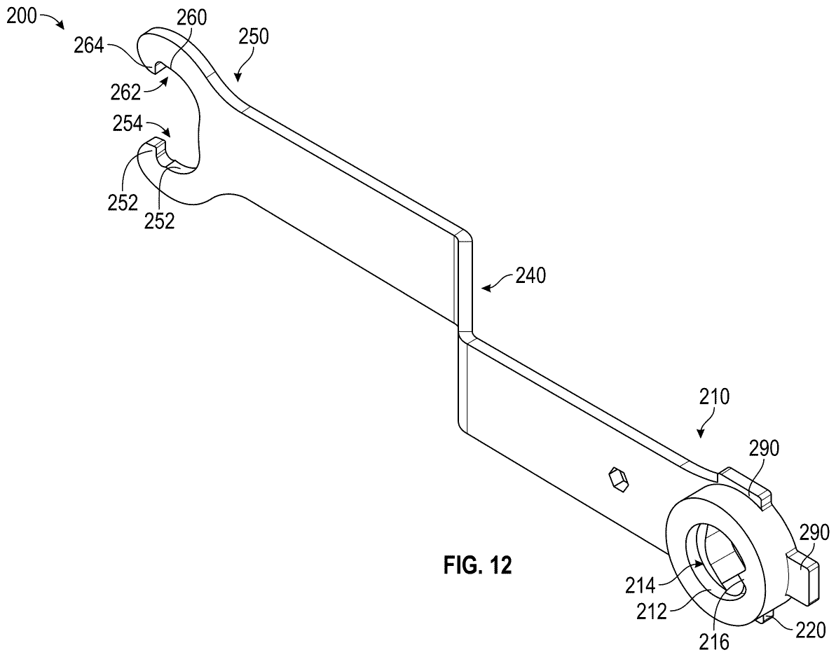

Referring to FIG. 12, an alternative embodiment of the solar wrench 200 is shown. The solar wrench 200 of FIG. 12 may be substantially similar to the solar wrench 200 of FIGS. 2-9 except as otherwise described herein. The solar wrench 200 of both FIG. 12 and FIG. 2-9 may facilitate installation of the solar panels 30 onto the roof 20 with the solar mounting system 100. By way of example, the installer may utilize the solar wrench 200 of FIG. 12 instead of the solar wrench 200 of FIG. 2-9 based on a desired characteristic of the installation.

In the solar wrench 200 of FIG. 12, the puck bolt interface 212 is centered in the handle portion 210 and the puck bolt opening 214 extends through the handle portion 210. Accordingly, this increases a strength of the handle portion 210 by increasing an amount of material in the puck bolt interface 212. This arrangement increases a torque that may be transferred from the solar wrench 200 to the first type of the fasteners of the solar mounting system 100. In the solar wrench 200 of FIG. 12, the second interface opening 262 is oriented towards the first interface opening 254 and the first interface opening 254 is oriented towards the second interface opening 262.

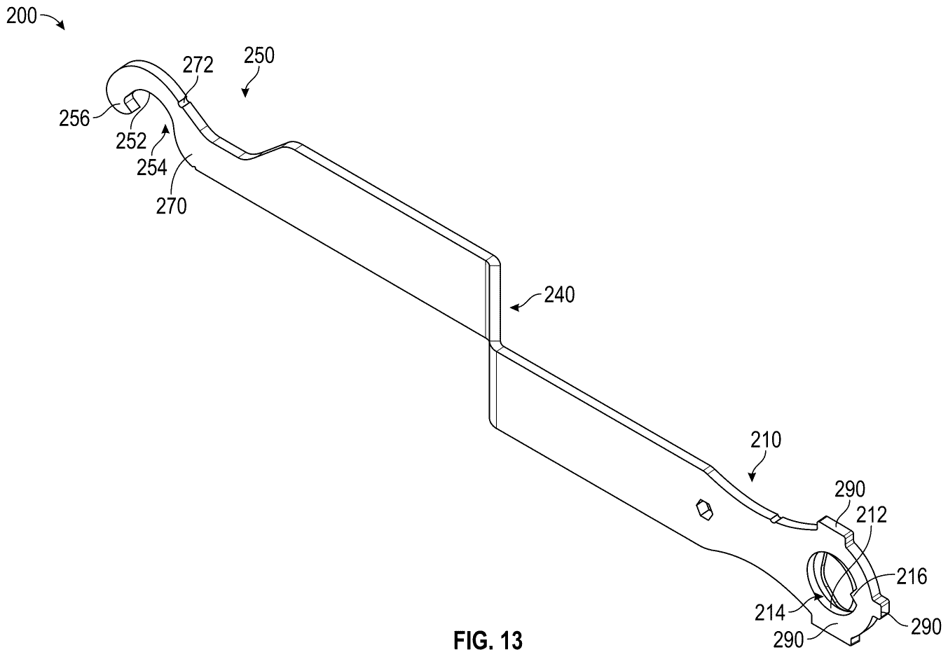

Referring to FIG. 13, an alternative embodiment of the solar wrench 200 is shown. The solar wrench 200 of FIG. 13 may be substantially similar to the solar wrench 200 of FIGS. 2-9 except as otherwise described herein. The solar wrench 200 of both FIG. 13 and FIG. 2-9 may facilitate installation of the solar panels 30 onto the roof 20 with the solar mounting system 100. By way of example, the installer may utilize the solar wrench 200 of FIG. 13 instead of the solar wrench 200 of FIG. 2-9 based on a desired characteristic of the installation.

In the solar wrench 200 of FIG. 13, the puck bolt interface 212 is centered in the handle portion 210 and the puck bolt opening 214 extends through the handle portion 210. Accordingly, this increases a strength of the handle portion 210 by increasing an amount of material in the puck bolt interface 212. This arrangement increases a torque that may be transferred from the solar wrench 200 to the first type of the fasteners of the solar mounting system 100.

In the solar wrench 200 of FIG. 13, the handle portion 210 does not includes the hybrid installation interface 220. Accordingly, the solar wrench 200 of FIG. 13 includes additional of the spacer tabs 290 extending from the handle portion 210. For example, the solar wrench 200 of FIG. 13 may include a first of the spacer tabs 290 with a first predetermined width extending from the handle portion 210, a second of the spacer tabs 290 with a second predetermined width extending from the handle portion 210, and a third of the spacer tabs 290 with a third predetermined width extending from the handle portion 210. In the solar wrench 200 of FIG. 13, the interface portion 250 does not include the second rotational interface 260.

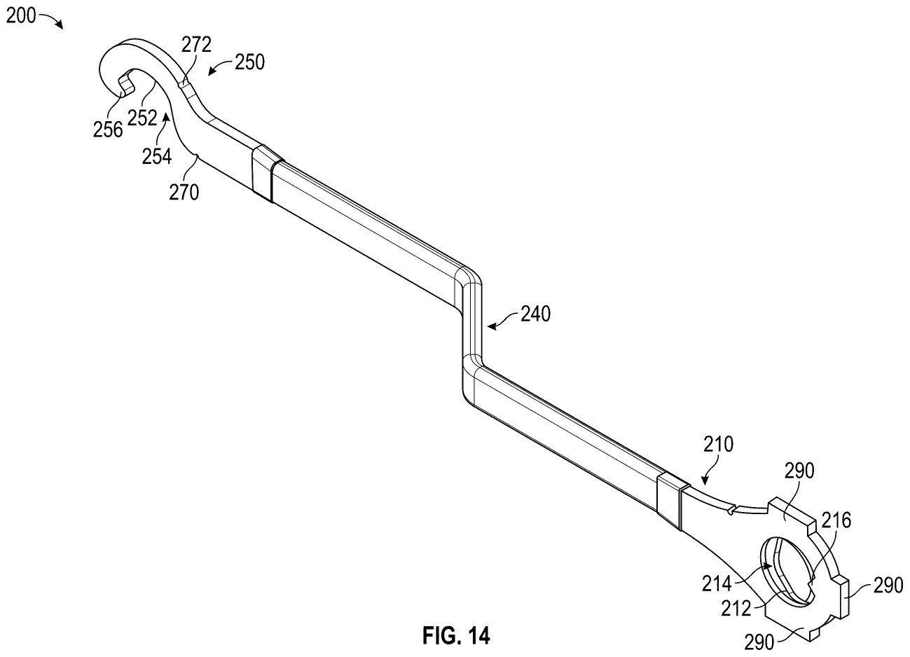

Referring to FIG. 14, an alternative embodiment of the solar wrench 200 is shown. The solar wrench 200 of FIG. 14 may be substantially similar to the solar wrench 200 of FIGS. 2-9 except as otherwise described herein. The solar wrench 200 of both FIG. 14 and FIG. 2-9 may facilitate installation of the solar panels 30 onto the roof 20 with the solar mounting system 100. By way of example, the installer may utilize the solar wrench 200 of FIG. 14 instead of the solar wrench 200 of FIG. 2-9 based on a desired characteristic of the installation.

In the solar wrench 200 of FIG. 14, the handle portion 210, the intermediate portion 240, and the interface portion 250 have a varying thickness. For example, a first thickness of the intermediate portion 240, a proximal portion of the handle portion 210 proximate the intermediate portion 240, and a proximal portion of the interface portion 250 proximate the intermediate portion 240 may be greater than a second thickness of a distal portion of the handle portion 210 distal to the intermediate portion 240 and a distal portion of the interface portion 250 distal to the intermediate portion 240.

In the solar wrench 200 of FIG. 14, the puck bolt interface 212 is centered in the handle portion 210 and the puck bolt opening 214 extends through the handle portion 210. Accordingly, this increases a strength of the handle portion 210 by increasing an amount of material in the puck bolt interface 212. This arrangement increases a torque that may be transferred from the solar wrench 200 to the first type of the fasteners of the solar mounting system 100.

In the solar wrench 200 of FIG. 14, the handle portion 210 does not includes the hybrid installation interface 220. Accordingly, the solar wrench 200 of FIG. 14 includes additional of the spacer tabs 290 extending from the handle portion 210. For example, the solar wrench 200 of FIG. 14 may include a first of the spacer tabs 290 with a first predetermined width extending from the handle portion 210, a second of the spacer tabs 290 with a second predetermined width extending from the handle portion 210, and a third of the spacer tabs 290 with a third predetermined width extending from the handle portion 210. In the solar wrench 200 of FIG. 14, the interface portion 250 does not include the second rotational interface 260.

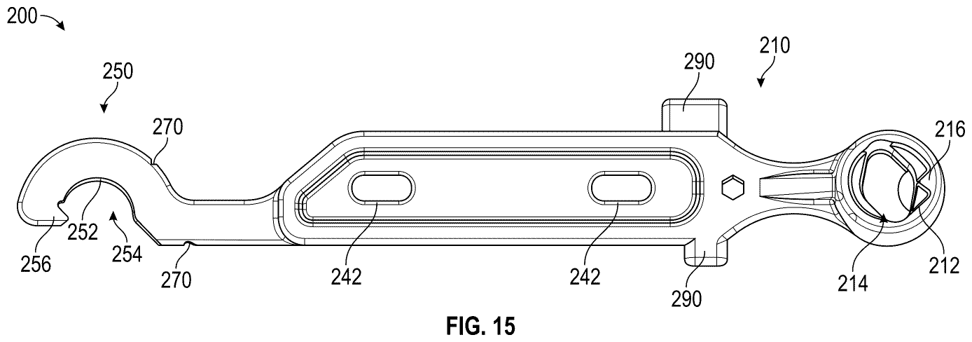

Referring to FIG. 15, an alternative embodiment of the solar wrench 200 is shown. The solar wrench 200 of FIG. 15 may be substantially similar to the solar wrench 200 of FIGS. 2-9 except as otherwise described herein. The solar wrench 200 of both FIG. 15 and FIG. 2-9 may facilitate installation of the solar panels 30 onto the roof 20 with the solar mounting system 100. By way of example, the installer may utilize the solar wrench 200 of FIG. 15 instead of the solar wrench 200 of FIG. 2-9 based on a desired characteristic of the installation.

In the solar wrench 200 of FIG. 15, the solar wrench 200 does not include the intermediate portion 240. For example, as shown in FIG. 15, the interface portion 250 extends directly from the handle portion 210. The handle portion 210 defines the lanyard apertures 242 extending through the handle portion 210. In the solar wrench 200 of FIG. 15, the handle portion 210 does not includes the hybrid installation interface 220. The spacer tabs 290 are positioned closer to the interface portion 250 than the puck bolt interface 212. In the solar wrench 200 of FIG. 15, the interface portion 250 does not include the second rotational interface 260.

In the solar wrench 200 of FIG. 15, the handle portion 210 and the interface portion 250 have a varying thickness. For example, a first portion of the handle portion 210 proximate the puck bolt interface 212 may be thicker than a second portion of the handle portion 210 proximate the lanyard apertures 242.

In the solar wrench 200 of FIG. 15, the puck bolt interface 212 is centered in the handle portion 210 and the puck bolt opening 214 extends through the handle portion 210. Accordingly, this increases a strength of the handle portion 210 by increasing an amount of material in the puck bolt interface 212. This arrangement increases a torque that may be transferred from the solar wrench 200 to the first type of the fasteners of the solar mounting system 100.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the solar wrench 200 as shown in the various exemplary embodiments is illustrative only. Additionally, any element disclosed in one embodiment may be incorporated or utilized with any other embodiment disclosed herein. For example, the handle portion 210 of the embodiment shown in at least FIG. 12 may be incorporated in the solar wrench 200 of the embodiment shown at least in FIG. 2-9. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A wrench for a solar mounting system, the wrench comprising:
a handle portion;
an intermediate portion extending from the handle portion; and
an interface portion extending from the intermediate portion, the interface portion including:
a first interface configured to engage a fastener to facilitate rotating the fastener in a first rotational direction; and
a second interface spaced from the first interface, the second interface configured to engage the fastener to facilitate rotating the fastener in an opposing second rotational direction.

2. The wrench of claim 1, wherein:
the first interface defines a first interface opening oriented in a first direction, the first interface opening configured to receive the fastener when the first interface engages the fastener, and
the second interface defines a second interface opening oriented in an opposing second direction, the second interface opening configured to receive the fastener when the second interface engages the fastener.

3. The wrench of claim 2, wherein:
the first interface includes a first tooth extending at least partially in the first direction, the first tooth configured to engage the fastener when the fastener is received by the first interface opening, and
the second interface includes a second tooth extending at least partially in the opposing second direction, the second tooth configured to engage the fastener when the fastener is received by the second interface opening.

4. The wrench of claim 3, wherein:
the first tooth extends at least partially into the first interface opening, and
the second tooth extends at least partially into the second interface opening.

5. The wrench of claim 2, wherein the second interface opening is positioned nearer the handle portion than the first interface opening.

6. The wrench of claim 1, further comprising a grip coupled to the handle portion, the grip configured to be grasped by an operator of the wrench.

7. The wrench of claim 6, wherein the handle portion defines a toothed profile configured to engage with interior portions of the grip.

8. The wrench of claim 1, wherein:
the fastener is a first fastener,
the handle portion includes a third interface configured to engage a second fastener of the solar mounting system,
the second fastener is a different type of fastener than the first fastener, and
the third interface defines a third interface opening configured to receive the second fastener when the third interface engages the second fastener.

9. The wrench of claim 8, wherein the handle portion includes a fourth interface configured to engage a component of the solar mounting system, the fourth interface positioned between the third interface and the intermediate portion.

10. The wrench of claim 1, further comprising a tab extending from the handle portion, the tab having a predetermined width for spacing apart solar panels by the predetermined width.

11. The wrench of claim 10, wherein the handle portion and the tab cooperatively define a carabiner aperture extending therethrough.

12. The wrench of claim 1, wherein:
the handle portion defines a first plane, and
the interface portion defines a second plane substantially parallel to the first plane, the second plane offset from the first plane.

13. The wrench of claim 12, wherein the intermediate portion defines one or more lanyard apertures extending therethrough.

14. The wrench of claim 1, wherein a length from an end of the interface portion to an end of the handle portion is greater than about 30 centimeters.

15. The wrench of claim 14, wherein a length from an end of the interface portion to an end of the handle portion is greater than or equal to about 32 centimeters.

16. The wrench of claim 1, wherein:
the interface portion defines a first alignment indicator and a second alignment indicator,
at least one of the first interface or the second interface is configured to engage a second fastener of the solar mounting system to rotate the second fastener,
aligning the first alignment indicator with a component of the solar mounting system while rotating the second fastener places the solar mounting system in a first configuration, and
aligning the second alignment indicator with the component of the solar mounting system while rotating the second fastener places the solar mounting system in a second configuration.

17. A wrench for a solar mounting system, the wrench comprising:
a first interface configured to engage a fastener to rotate the fastener in a first rotational direction, the first interface defining a first interface opening oriented in a first direction, the first interface opening configured to receive the fastener when the first interface engages the fastener; and
a second interface configured to engage the fastener to rotate the fastener in an opposing second rotational direction, the second interface defining a second interface opening oriented in an opposing second direction, the second interface opening configured to receive the fastener when the second interface engages the fastener.

18. The wrench of claim 17, wherein the first interface opening is oriented towards the second interface opening.

19. The wrench of claim 17, wherein the first interface opening is oriented away from the second interface opening.

20. A wrench for a solar mounting system, the wrench comprising:
an interface portion defining a first interface and a second interface, the interface portion defining a first plane, the interface portion configured to separately engage a first fastener with the first interface to facilitate rotating the first fastener in a first rotational direction or the second interface to facilitate rotating the first fastener in a second rotational direction; and
a handle portion coupled to the interface portion, the handle portion defining a second plane offset from the first plane, the handle portion defining a third interface configured to engage a second fastener of the solar mounting system and a fourth interface configured to engage a component of the solar mounting system, the fourth interface positioned between the third interface and the interface portion,
wherein:
the first interface includes a first tooth extending from a first side of the interface portion, the first tooth configured to engage a notch of the first fastener,
the second interface include a second tooth extending from an opposing second side of the interface portion, the second tooth configured to engage the notch of the first fastener, and
the second fastener is a different type of fastener than the first fastener.
